(19) United States
(12) Patent Application Publication
(10) Pub. No.: US 2025/0014020 A1
(43) Pub. Date: Jan. 9, 2025

(54) SYSTEM AND METHOD FOR REDUCING CROSS-CURRENCY TRANSACTIONS

(71) Applicant: Visa International Service Association, San Francisco, CA (US)

(72) Inventor: Millie Ling YEE, Santa Clara, CA (US)

(73) Assignee: Visa International Service Association, San Francisco, CA (US)

(21) Appl. No.: 18/347,421

(22) Filed: Jul. 5, 2023

(51) Int. Cl. G06Q 20/38; G06Q 20/40

(52) U.S. Cl. CPC G06Q 20/381; G06Q 20/40

(57) ABSTRACT

A system is configured to determine whether a first exchange rate at the time of authorization is eligible to be used as the exchange rate at the time of clearing. The system evaluates the transaction with a scoring model and stores eligible transactions in a rate matching database. The system further evaluates the transaction with a cross-currency transaction policy, according to the currency exchange rate between a foreign currency and the domestic currency of the cardholder. The system queries the rate matching database to retrieve the first exchange rate stored at the time of authorization.

### TECHNICAL FIELD

A method and system for identifying cross-currency transactions that are eligible for rate matching during an authorization phase of transaction requests and the eligible transaction are queried from a database during a clearing phase.

### SUMMARY

In one aspect, the present disclosure provides a method comprising: receiving, by a computer system, a transaction request to authorize a first transaction, wherein the transaction request comprises a transaction amount in a first currency and transaction information; determining, by the computer system, a first exchange rate between the first currency and a second currency, wherein the first exchange rate is determined at an authorization time; calculating, by the computer system, a rate matching score for the first transaction according to an exchange rate scoring model, wherein the rate matching score indicates a suitability to calculate a clearing transaction amount with the first exchange rate at a clearing time; determining, by the computer system, the rate matching score meets a threshold score, wherein the threshold score for calculating the clearing transaction amount with the first exchange rate at the clearing time; storing, by the computer system, the transaction information and the first exchange rate to a rate matching database, at the authorization time; and transmitting, by the computer system, a notification to an issuer system, wherein the notification comprises an authorization transaction amount in the second currency, and wherein the authorization transaction amount is based on the first exchange rate, and wherein the notification is transmitted before the clearing time.

In another aspect, the present disclosure provides a system comprising: a payment processing server comprising one or more processors coupled to a memory, the memory comprising instructions stored thereon, cause the payment processing server to: receive a transaction request to authorize a first transaction, wherein the transaction request comprises a transaction amount in a first currency and transaction information; determine a first exchange rate between the first currency and a second currency, wherein the first exchange rate is determined at an authorization time; calculate a rate matching score for the first transaction according to an exchange rate scoring model, wherein the rate matching score indicates a suitability to calculate a clearing transaction amount with the first exchange rate at a clearing time; determine the rate matching score meets a threshold score, wherein the threshold score for calculating the clearing transaction amount with the first exchange rate at the clearing time; store the transaction information and the first exchange rate to a rate matching database, at the authorization time; and transmit a notification to an issuer system, wherein the notification comprises an authorization transaction amount in the second currency, and wherein the authorization transaction amount is based on the first exchange rate, and wherein the notification is transmitted before the clearing time.

In yet another aspect, the present disclosure provides a method comprising: receiving, by a computer system, a transaction request to authorize a first transaction, wherein the transaction request comprises a transaction amount in a first currency and transaction information; determining, by the computer system, a first exchange rate between the first currency and a second currency, wherein the first exchange rate is determined at an authorization time; calculating, by the computer system, a rate matching score for the first transaction according to an exchange rate scoring model, wherein the rate matching score indicates a suitability to calculate a clearing transaction amount with the first exchange rate at a clearing time; determining, by the computer system, the rate matching score meets a threshold score, wherein the threshold score for calculating the clearing transaction amount with the first exchange rate at the clearing time; storing, by the computer system, the transaction information and the first exchange rate to a rate matching database, at the authorization time; evaluating, by the computer system, a cross-currency transaction policy during the clearing time; determining, by the computer system, the first transaction is eligible to use the first exchange rate to calculate the transaction amount in the second currency at the clearing time, based on the cross-currency transaction policy; generating, by the computer system, the clearing transaction amount based on the first exchange rate; and transmitting, by the computer system, the clearing transaction amount and an electronic draft capture associated with the transaction request to an issuer system.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 shows a system architecture for a payment network comprising a merchant device, an acquirer system, a payment processing server, an issuer system, and a customer device communicably coupled through the payment network, according to at least one aspect of the present disclosure.

FIG. 2 shows a logic flow diagram for authorizing a transaction request by a payment processing server for a cross-currency transaction, according to at least one aspect of the present disclosure.

FIG. 3 shows a logic flow diagram for clearing a transaction request by a payment processing server, according to at least one aspect of the present disclosure.

FIG. 4 shows a system architecture for a payment network comprising a payment processing server communicably coupled to a rate matching database and a training server, according to at least one aspect of the present disclosure.

FIG. 5 is a block diagram of a computer apparatus with data processing subsystems or components, according to at least one aspect of the present disclosure.

FIG. 6 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The term “acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as a “transport computer”.

As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting embodiments or aspects, an acquirer may be a financial institution, such as a bank.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

The terms “issuer institution.” “issuer system,” “issuer server.” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” or “merchant device” may refer to one or more computer systems operated by or on behalf of a merchant, such as a server computer executing one or more software applications used to facilitate a transaction by a customer.

As used herein, a “customer device” may include a “computing device” or “mobile device” and may comprise any electronic device that may be operated and/or transported by a user, which also may provide remote communication capabilities to a network and may be referred to as a mobile device and may comprise a fixed device. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A computing device may comprise any suitable hardware and software for performing such functions, and may also include multiple devices or components (e.g. when a computing device has remote access to a network by tethering to another device—e.g., using the other device as a modem-both devices taken together may be considered a single mobile device). A computing device also may comprise a verification token in the form of, for instance, a secured hardware or software component within the computing device and/or one or more external components that may be coupled to the mobile device. A detailed description of an exemplary mobile device is provided below.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

As used herein, the term “payment processing server” may refer to an entity that receives transaction authorization requests from merchants, merchant device or other entities and provides guarantees of payment, in some cases through an agreement between the merchant and an issuer. For example, a central payment server may include a payment network, such as Visa®, MasterCard®, American Express®, or any other entity that processes transactions. As used herein “central payment server” may refer to one or more systems operated by or operated on behalf of a central payment server, such as a executing one or more software applications associated with central payment server. In some non-limiting embodiments or aspects, a central payment server may include one or more server computers with one or more processors and, in some non-limiting embodiments or aspects, may be operated by or on behalf of a central payment service provider.

The present disclosure describes a method and system for identifying cross-currency transactions that are eligible for rate matching. The system comprises a rate matching database that advantageously provides the payment processing server with a currency exchange rate, between a foreign currency and the domestic currency of the cardholder. The system calculates the first exchange rate at the time of authorization, and determines whether the first exchange rate, associated with the transaction, is eligible to be used as the exchange rate for the transaction, at the time of clearing. For many dual message cross-currency transactions, it is common for the authorized transaction amount, in the domestic currency amount, to be unknown until the final transaction amount is calculated at the time of clearing. The domestic currency amount may not be known because the exchange rate may change between the time of the authorization and the time of clearing. This problem particularly effects cross-currency transactions because the transaction amount in the domestic currency it directly calculated by the exchange rate at the time of clearing. Many factors may contribute to a fluctuation in an exchange rate between the authorization and clearing. These factors may include the merchant type, the transaction amount, the foreign and domestic currency types, the number of transaction performed by the merchant, other time factors that create a time delay between the authorization and the clearing, etc. Accordingly, the present disclosure provides a two part evaluation system performed at the time of authorization and clearing to provide exchange rate matching between authorization and clearing. Although not all cross-currency transactions will be eligible, the eligible transactions help improve financial certainty for issuer systems and customers, prevent over-drafting customer accounts, and under capitalization of issuer systems.

The customer is usually unaware of the complexity that is involved for cross-currency transaction and therefore they are often confused when there is a discrepancy between an authorization amount and a clearing amount. The customers may contact the issuer to between understand the amount discrepancies and this can lead to increased call volume to customer support centers of the issuer and payment network. Accordingly, another advantages of the present disclosure is a decrease in call volume by customers.

In one example of a conventional cross-currency transaction, the issuer system associated with the customer is not aware of the final transaction amount until they receive the clearing request from the payment processing server. Although, the issuer system provides the customer with a pending transaction amount at the time of authorization, this amount can often change at the time of clearing. Additionally, it may be possible for multiple pending transactions, with unknown amounts, to clear on the same day and result in an overdraft on the customer account or an undercapitalization of the issuer system. In contrast, the present disclosure allows eligible transactions to use the first exchange rate at the time of authorization to calculate a transaction amount that is used for the clearing amount.

In various aspects, the payment processing server employs a machine learning model that receives various input parameters of the transaction request to predict whether a given cross-currency transaction is eligible for exchange rate matching and stores the eligible transactions in a rate matching database. During the clearing phase of the transaction amount, the payment processing server performs a policy based evaluation to identify eligible transactions stored in the rate matching database and queries the authorization exchange rate from the rate matching database to use as the clearing exchange rate. Therefore, eligible cross-currency transactions appear in a similar manner as domestic currency transaction, from the perspective of the customer and issuer system.

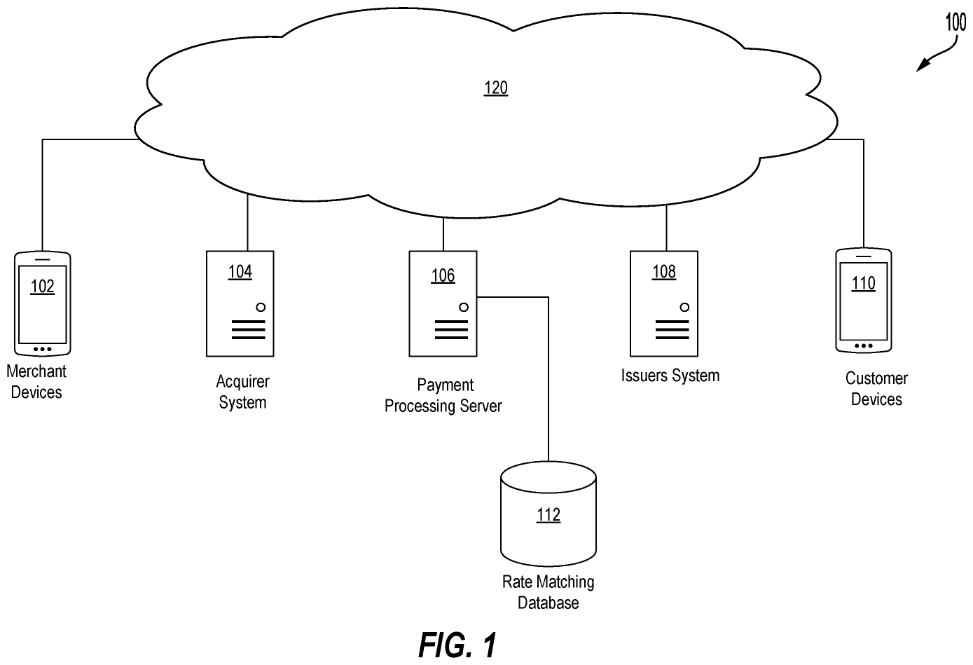

FIG. 1 shows a system architecture 100 for a payment network 120 comprising a merchant device 102, an acquirer system 104, a payment processing server 106, an issuer system 108, and a customer device 110 communicably coupled through the payment network 120, according to at least one aspect of the present disclosure. The payment processing server is coupled to a rate matching database 112 or comprises the rate matching database as part of the payment processing server 106.

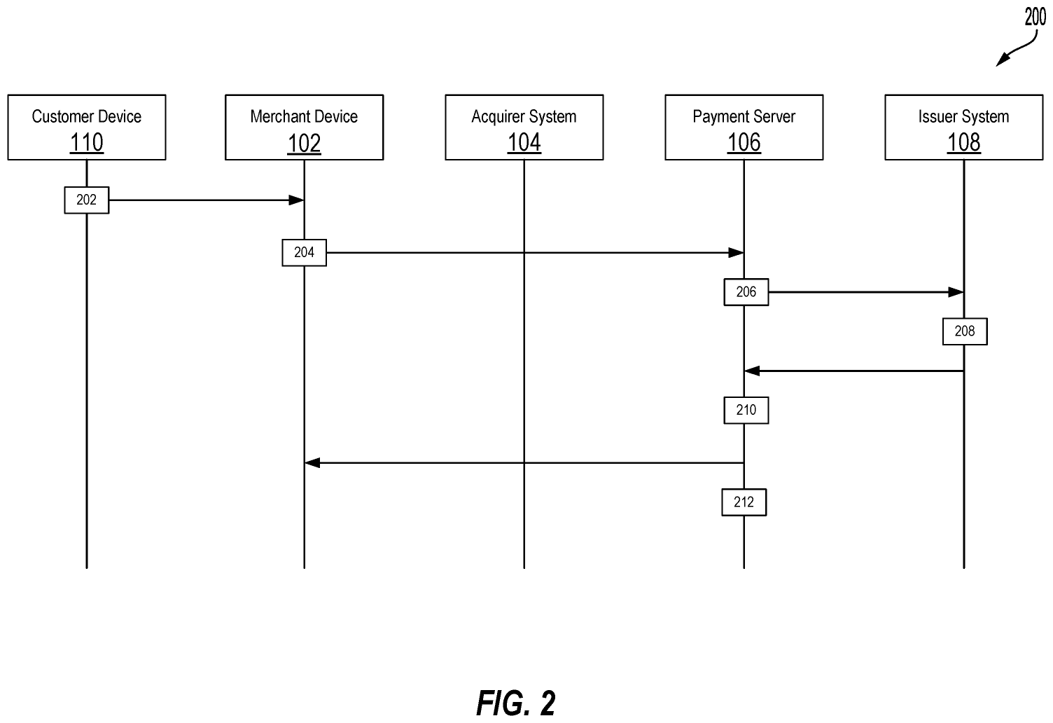

FIG. 2 shows a logic flow diagram 200 for authorizing a transaction request by a payment processing server 106 for a cross-currency transaction, according to at least one aspect of the present disclosure. Typically, the authorization process and the clearing processing are performed independently of each other. However, in order to evaluate transactions for exchange the payment processing server 106 coordinates the authorization process and the clearing process for eligible transactions. The authorization process begins when a customer or customer device 110 initiates 202 a financial transaction with a merchant device 102. The merchant device receives 204 the customer payment information along with the transaction request details and forwards transaction information, through the acquirer system, to the payment processing server 106. In various aspects, the customer payment information includes a primary account number (PAN) of payment account associated with the customer or the customer device 110.

The payment processing server 106 receives the transaction information and evaluates 206 the cross-currency transaction with the machine learning model to determine a rate matching score for the cross currency transaction. The payment processing server 106may determine if the transaction is eligible for exchange rate matching based on the rate matching score. In one aspect, the payment processing server 106 determines that transaction is eligible for rate matching, and stores the transaction information in the rate matching database 112. In another aspect, the payment processing server 106 may wait to store the transaction information in the rate matching database until a response is received by the issuer system 108.

After payment processing server 106 determines the rate matching score, the payment processing server 106 identifies 208 the issuer system 108 associated with the customer 110 and forwards the transaction request information, the customer payment information, and the rate matching score to the issuer system 108. The issuer system 108 evaluates the transaction information and sends 210 an authorization status message to the payment processing server 106, that indicates whether the transaction request was approved or denied. Optionally, the payment processing server 106 stores 212 the transaction information in the rate matching database based on a response from the issuer system 108. Additionally, the payment processing server 106 forwards the authorization status message to the merchant device 102, through the acquirer system 104, to indicate whether the transaction was approved or denied.

In various aspects, the payment processing server 106 evaluates the transaction information with a multi-input rate matching scoring model that generates a rate matching score for cross-currency transaction. The rate matching score may correlate to the level of change that is predicted for the transaction amount, between the time of authorization and the time of clearing, or the exchange rate itself. In various aspect, the rate matching scoring model is a supervised deep learning model that uses the transaction information, historical data, and other input variables to predict the likelihood that the transaction amount at the time of authorization matches the amount at clearing. If the generated score meets a threshold level, the transaction request is deemed eligible for exchange rate matching and the transaction information is stored in the rate matching database 112 with the exchange rate at the time of authorization. Eligible transactions may be stored as new entries and the entries may include merchant identifying information, purchase categories (e.g., entertainment, dining, service, hospitality, transportation, etc.), the timestamp of the authorization, the amount of the transaction in the foreign currency, the amount of the transaction in the domestic currency based on the exchange rate at the time of authorization, or other input variables that may impact the exchange rate.

In one example, a customer may check into a hotel for 7 day and their payment method is authorized at the time of check-in. The payment processing server 106 calculates a rate matching score, with the scoring model, for the hotel transaction. The generate score is well below the threshold for rate matching and indicates that there is a substantial probability that the exchange rate at the time of authorization with be different from the exchange rate at the time of clearing. The multi-input scoring model may be trained on similar transaction data that show transactions with this merchant and/or in the purchase category are highly weighted against meeting the threshold level for rate matching.

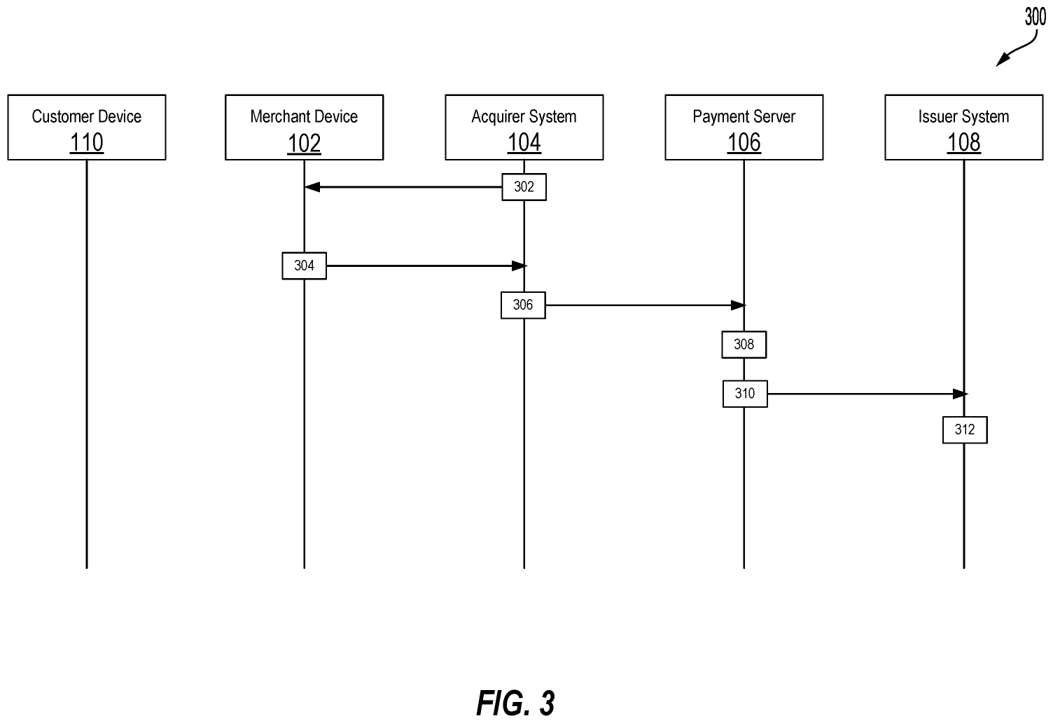

FIG. 3 shows a logic flow diagram 300 for clearing a transaction request by a payment processing server 103, according to at least one aspect of the present disclosure. The merchant device 102 receives 302 authorization status message for the customer transaction request, from the acquirer system 104. In response, the merchant 102 stores the authorized transaction data, associated with the transaction request by the customer 110, as an electronic draft capture (EDC). The EDC is stored with a plurality of EDCs associated with other customer transaction, and allows the merchant to submit the plurality of EDCs as a batch process. The merchant 102 initiates 304 the clearing process by transmitting the plurality of EDCs to the acquirer system 104 for periodic batch processing. The merchant 102 may transmit batches based on the number of expected transaction. In one example, a merchant 102 in the restaurant purchase category may expect a high volume of customers on Thursdays-Saturdays. Accordingly, the restaurant may transmit multiple EDC batch for processing in a single day on Thursdays-Saturdays. In this example, the time between the authorization of the transaction and the clearing may be less than two hours and would make for a good candidate for rate matching. In another example, the same merchant 102 may have substantially fewer customers on Sundays through Wednesday. Accordingly, the merchant 102 may transmit batch EDCs every other day. A transaction that is authorized on Sunday morning may be submit for clearing until Monday evening and would make for a poor candidate for rate matching. However, the merchant 102 may be required to submit the EDC to the acquirer within a predetermined amount of time from authorization, in order for the issuer system 108 to honor the authorized transaction. Once the acquirer system receives the plurality of EDCS, the acquirer system 104 forwards 306 the EDCs to the payment processing server 106. The payment processing server 106 receives the plurality of EDCs and evaluates 308 the cross-currency transaction according to a set of policies. The payment processing server 106 again determines whether the transaction is eligible for rate matching and queries the rate matching database 112 for the transaction information at the time of authorization.

In one example, the payment processing server 106 determines with the rate matching scoring model that a transaction is eligible for rate matching, and stores the transaction information in the rate matching database 112. However, the policies at the time of clearing indicate that the transaction is ultimately ineligible for rate matching. In another example, the payment processing server 106 determines with the rate matching scoring model that the transaction is ineligible, and does not store the transaction information in the rate matching database 112. In response to the policies at the time of clearing, the payment processing server 106 queries the rate matching database 112, but does not return any results for the transaction, and ultimately determines that the transaction is ineligible for rate matching.

In various aspects, the payment processing server 106 limits the queries of the rate matching database 112 based on a historical score for eligible merchants 102 or acquirer systems 104, where the transactions are submitted to clearing within a predetermined time from authorization (e.g., within 7 days). For an eligible transaction, the payment processing server 106 determines the domestic currency transaction amount based on the exchange rate at the time of authorization. For an ineligible transaction, the payment processing server 106 calculates the domestic currency transaction amount based on the current exchange rate at the time of clearing. The payment processing server 106 routes the domestic currency transaction amount and the EDC to the respective issuer system 108. The issuer system 108 creates a clearing draft for the transaction. Additionally, the issuer system 108 may consolidate a plurality of clearing drafts to perform a settlement process with the acquirer system 104.

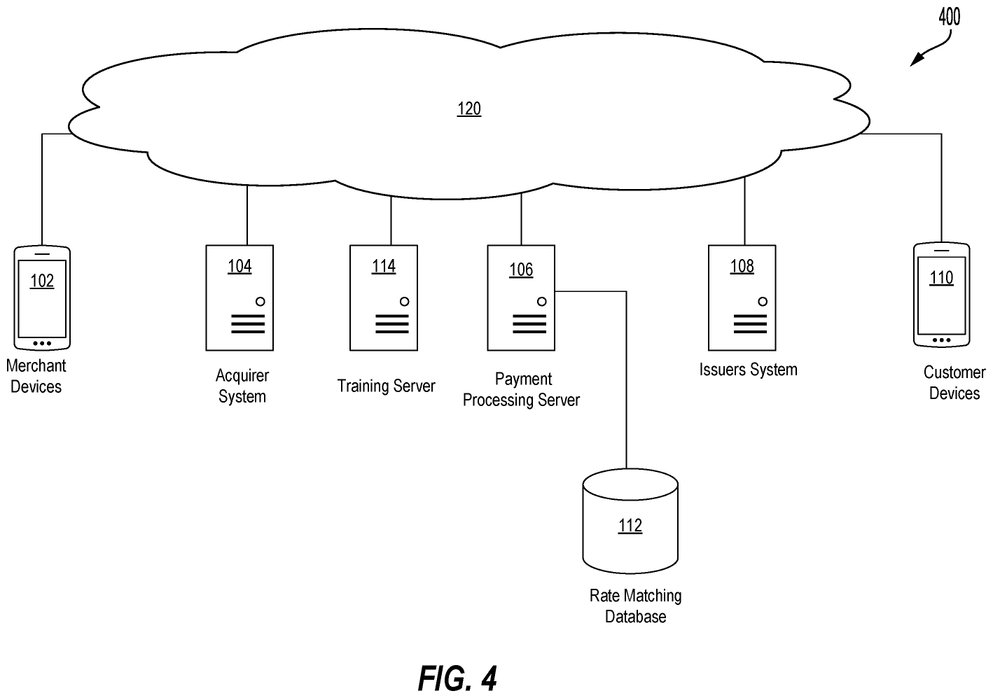

FIG. 4 shows a system architecture 400 for a payment network 120 comprising a payment processing server 106 communicably coupled to a rate matching database 112 and a training server 114, according to at least one aspect of the present disclosure. The payment processing server 106 may be configured to identify cross-currency transaction and store detailed transaction information in the training server 114 including: domestic currency type (e.g., USD, EUR, JPY, CHF, AUD, GBP, Etc.), foreign currency (e.g., USD, EUR, JPY, CHF, AUD, GBP, Etc.), authorization time (e.g., unix timestamp), exchange rate at the authorization time (e.g., 1.35347, 0.8376, 0.91166), clearing time (e.g., unix timestamp), and exchange rate at the clearing time (e.g., 1.35347, 0.8342, 0.91201). The training server 114 is not used for live rate matching transaction but may be used to improve the rate matching scoring model, for future transactions. In one example, the training server 114 identifies an unacceptable level of change between an authorized transaction and a cleared transaction that was previously determined to be eligible for rate matching. The training server 114 may correlate the unacceptable level of change to a specific purchase scenario that includes the merchant category, purchase category, or other transaction data. In response, the training server 114 stores all cross-currency transaction data that meets the specific purchase scenario during the authorization process. At clearing, the training server 114 updates the transaction entries with the exchange rate information at the time of clearing. Once the training date is stored for the time of authorization and clear, the training server 114 may re-training the rate matching scoring model for the specific purchase scenario. The training server 114 may recalibrate weightings or best fit lines of the model so that the rate matching score aligns with the minimum acceptable level of change for a foreign exchange rate in a specific purchase scenario. It is further appreciated that different purchase scenarios correspond to different thresholds for a minimum acceptable level of change. For example, some purchase scenarios may be highly sensitive to exchange rate fluctuation and any amount of rate change would be deemed unacceptable (e.g., transaction amount exceeds a predetermined amount of money in one or both of the domestic currency and the foreign currency). In contrast, a transaction request for the purchase of a single coffee at a coffee shop may have a lower threshold to meet for exchange rate matching. Additionally, the merchant information may be highly weighted if the merchant 102 has a history of processing EDCs batches in a predetermined amount of time (e.g., 2 hours, 2 days).

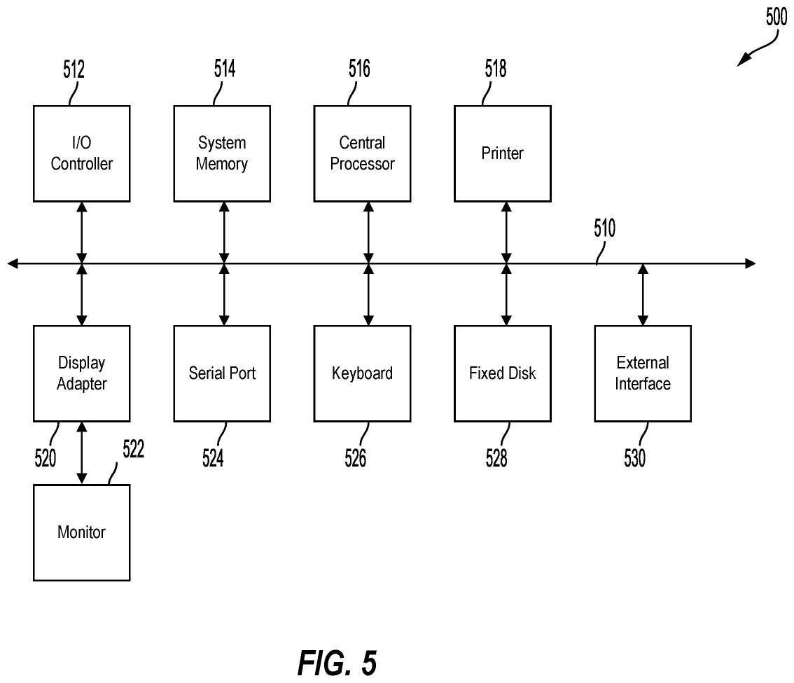

FIG. 5 is a block diagram of a computer apparatus 500 with data processing subsystems or components, according to at least one aspect of the present disclosure. The subsystems shown in FIG. 5 are interconnected via a system bus 510. Additional subsystems such as a printer 518, keyboard 526, fixed disk 528 (or other memory comprising computer readable media), monitor 522, which is coupled to a display adapter 520, and others are shown. Peripherals and input/output (I/O) devices, which couple to an I/O controller 512 (which can be a processor or other suitable controller), can be connected to the computer system by any number of means known in the art, such as a serial port 524. For example, the serial port 524 or external interface 530 can be used to connect the computer apparatus to a wide area network such as the Internet, a mouse input device, or a scanner. The interconnection via system bus allows the central processor 516 to communicate with each subsystem and to control the execution of instructions from system memory 514 or the fixed disk 528, as well as the exchange of information between subsystems. The system memory 514 and/or the fixed disk 528 may embody a computer readable medium.

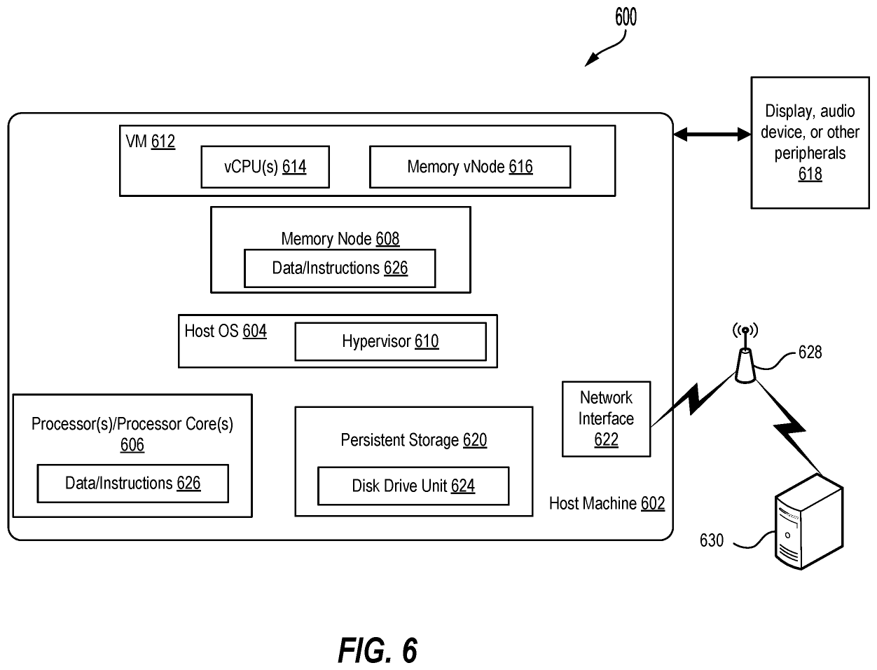

FIG. 6 is a diagrammatic representation of an example system 600 that includes a host machine 602 within which a set of instructions to perform any one or more of the methodologies discussed herein may be executed, according to at least one aspect of the present disclosure. In various aspects, the host machine 602 operates as a standalone device or may be connected (e.g., networked) to other machines. In a networked deployment, the host machine 602 may operate in the capacity of a server or a client machine in a server-client network environment, or as a peer machine in a peer-to-peer (or distributed) network environment. The host machine 602 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 600 includes the host machine 602, running a host operating system (OS) 604 on a processor or multiple processor(s)/processor core(s) 606 (e.g., a central processing unit (CPU), a graphics processing unit (GPU), or both), and various memory nodes 608. The host OS 604 may include a hypervisor 610 which is able to control the functions and/or communicate with a virtual machine (“VM”) 612 running on machine readable media. The VM 4012 also may include a virtual CPU or vCPU 614. The memory nodes 608 may be linked or pinned to virtual memory nodes or vNodes 616. When the memory node 608 is linked or pinned to a corresponding vNode 616, then data may be mapped directly from the memory nodes 608 to their corresponding vNodes 616.

All the various components shown in host machine 602 may be connected with and to each other, or communicate to each other via a bus (not shown) or via other coupling or communication channels or mechanisms. The host machine 602 may further include a video display, audio device or other peripherals 618 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 620 (also referred to as disk drive unit), and a network interface device 622. The host machine 602 may further include a data encryption module (not shown) to encrypt data. The components provided in the host machine 602 are those typically found in computer systems that may be suitable for use with aspects of the present disclosure and are intended to represent a broad category of such computer components that are known in the art. Thus, the system 600 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 624 also may be a Solid-state Drive (SSD), a hard disk drive (HDD) or other includes a computer or machine-readable medium on which is stored one or more sets of instructions and data structures (e.g., data/instructions 626) embodying or utilizing any one or more of the methodologies or functions described herein. The data/instructions 626 also may reside, completely or at least partially, within the main memory node 608 and/or within the processor(s) 606 during execution thereof by the host machine 602. The data/instructions 626 may further be transmitted or received over a network 4028 via the network interface device 622 utilizing any one of several well-known transfer protocols (e.g., Hyper Text Transfer Protocol (HTTP)).

The processor(s) 606 and memory nodes 608 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 602 and that causes the host machine 602 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A method comprising: receiving, by a computer system, a transaction request to authorize a first transaction, wherein the transaction request comprises a transaction amount in a first currency and transaction information; determining, by the computer system, a first exchange rate between the first currency and a second currency, wherein the first exchange rate is determined at an authorization time; calculating, by the computer system, a rate matching score for the first transaction according to an exchange rate scoring model, wherein the rate matching score indicates a suitability to calculate a clearing transaction amount with the first exchange rate at a clearing time; determining, by the computer system, the rate matching score meets a threshold score, wherein the threshold score for calculating the clearing transaction amount with the first exchange rate at the clearing time; storing, by the computer system, the transaction information and the first exchange rate to a rate matching database, at the authorization time; and transmitting, by the computer system, a notification to an issuer system, wherein the notification comprises an authorization transaction amount in the second currency, and wherein the authorization transaction amount is based on the first exchange rate, and wherein the notification is transmitted before the clearing time.

Clause 2. The method of Clause 1, further comprising: receiving, by the computer system, an electronic draft capture associated with the transaction request; evaluating, by the computer system, a cross-currency transaction policy during the clearing time; determining, by the computer system, the first transaction is eligible to use the first exchange rate to calculate the transaction amount in the second currency at the clearing time, based on the cross-currency transaction policy; transmitting, by the computer system, a rate matching request to the rate matching database, wherein the rate matching request comprises the transaction information necessary to determine the first exchange rate; generating, by the computer system, the clearing transaction amount based on the first exchange rate; and transmitting, by the computer system, the clearing transaction amount and the electronic draft capture to the issuer system.

Clause 3. The method of Clauses 1-2, wherein the rate matching score is determined based on the transaction information of the transaction request, historical information for a merchant, and the exchange rate scoring model.

Clause 4. The method of Clause 3, wherein the transaction information comprises a merchant identifier, a foreign transaction amount, a purchase category of the first transaction, and a merchant category.

Clause 5. The method of Clauses 1-4, wherein the first currency is a foreign currency relative to a customer and wherein the second currency is a domestic currency relative to the customer.

Clause 6. The method of Clauses 1-5, wherein the rate matching score is based on a foreign transaction amount, the first currency, and the second currency.

Clause 7. The method of Clauses 1-6, wherein the exchange rate scoring model comprises a supervised deep learning model.

Clause 8. The method of Clauses 2-7, wherein the cross-currency transaction policy is based on historical information for a merchant, a foreign transaction amount, a purchase category of the first transaction, and a merchant category.

Clause 9. The method of Clauses 2-7, wherein the cross-currency transaction policy is based on historical information for a merchant.

Clause 10. A system comprising: a payment processing server comprising one or more processors coupled to a memory, the memory comprising instructions stored thereon, cause the payment processing server to: receive a transaction request to authorize a first transaction, wherein the transaction request comprises a transaction amount in a first currency and transaction information; determine a first exchange rate between the first currency and a second currency, wherein the first exchange rate is determined at an authorization time; calculate a rate matching score for the first transaction according to an exchange rate scoring model, wherein the rate matching score indicates a suitability to calculate a clearing transaction amount with the first exchange rate at a clearing time; determine the rate matching score meets a threshold score, wherein the threshold score for calculating the clearing transaction amount with the first exchange rate at the clearing time; store the transaction information and the first exchange rate to a rate matching database, at the authorization time; and transmit a notification to an issuer system, wherein the notification comprises an authorization transaction amount in the second currency, and wherein the authorization transaction amount is based on the first exchange rate, and wherein the notification is transmitted before the clearing time.

Clause 11. The system of Clause 10, wherein the instructions further cause the payment processing server to: receive an electronic draft capture associated with the transaction request; evaluate a cross-currency transaction policy during the clearing time; determine the first transaction is eligible to use the first exchange rate to calculate the transaction amount in the second currency at the clearing time, based on the cross-currency transaction policy; transmit a rate matching request to the rate matching database, wherein the rate matching request comprises the transaction information necessary to determine the first exchange rate; generate the clearing transaction amount based on the first exchange rate; and transmit the clearing transaction amount and the electronic draft capture to the issuer system.

Clause 12. The system of Clauses 10-11, wherein the rate matching score is determined based on the transaction information of the transaction request, historical information for a merchant, and the exchange rate scoring model.

Clause 13. The system of Clause 12, wherein the transaction information comprises a merchant identifier, a foreign transaction amount, a purchase category of the first transaction, and a merchant category.

Clause 14. The system of Clauses 10-13, wherein the first currency is a foreign currency relative to a customer and wherein the second currency is a domestic currency relative to the customer.

Clause 15. The system of Clauses 10-14, wherein the rate matching score is based on a foreign transaction amount, the first currency, and the second currency.

Clause 16. The system of Clause 10-15, wherein the exchange rate scoring model comprises a supervised deep learning model.

Clause 17. The system of Clause 11-16, wherein the cross-currency transaction policy is based on historical information for a merchant, a foreign transaction amount, a purchase category of the first transaction, and a merchant category.

Clause 18. The system of Clauses 11-16, wherein the cross-currency transaction policy is based on historical information for a merchant.

Clause 19. A method comprising: receiving, by a computer system, a transaction request to authorize a first transaction, wherein the transaction request comprises a transaction amount in a first currency and transaction information; determining, by the computer system, a first exchange rate between the first currency and a second currency, wherein the first exchange rate is determined at an authorization time; calculating, by the computer system, a rate matching score for the first transaction according to an exchange rate scoring model, wherein the rate matching score indicates a suitability to calculate a clearing transaction amount with the first exchange rate at a clearing time; determining, by the computer system, the rate matching score meets a threshold score, wherein the threshold score for calculating the clearing transaction amount with the first exchange rate at the clearing time; storing, by the computer system, the transaction information and the first exchange rate to a rate matching database, at the authorization time; evaluating, by the computer system, a cross-currency transaction policy during the clearing time; determining, by the computer system, the first transaction is eligible to use the first exchange rate to calculate the transaction amount in the second currency at the clearing time, based on the cross-currency transaction policy; generating, by the computer system, the clearing transaction amount based on the first exchange rate; and transmitting, by the computer system, the clearing transaction amount and an electronic draft capture associated with the transaction request to an issuer system.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method comprising:
receiving, by a computer system, a transaction request to authorize a first transaction, wherein the transaction request comprises a transaction amount in a first currency and transaction information;
determining, by the computer system, a first exchange rate between the first currency and a second currency, wherein the first exchange rate is determined at an authorization time;
calculating, by the computer system, a rate matching score for the first transaction according to an exchange rate scoring model, wherein the rate matching score indicates a suitability to calculate a clearing transaction amount with the first exchange rate at a clearing time;
determining, by the computer system, the rate matching score meets a threshold score, wherein the threshold score for calculating the clearing transaction amount with the first exchange rate at the clearing time;
storing, by the computer system, the transaction information and the first exchange rate to a rate matching database, at the authorization time; and
transmitting, by the computer system, a notification to an issuer system, wherein the notification comprises an authorization transaction amount in the second currency, and wherein the authorization transaction amount is based on the first exchange rate, and wherein the notification is transmitted before the clearing time.

2. The method of claim 1, further comprising:
receiving, by the computer system, an electronic draft capture associated with the transaction request;
evaluating, by the computer system, a cross-currency transaction policy during the clearing time;
determining, by the computer system, the first transaction is eligible to use the first exchange rate to calculate the transaction amount in the second currency at the clearing time, based on the cross-currency transaction policy;
transmitting, by the computer system, a rate matching request to the rate matching database, wherein the rate matching request comprises the transaction information necessary to determine the first exchange rate;
generating, by the computer system, the clearing transaction amount based on the first exchange rate; and
transmitting, by the computer system, the clearing transaction amount and the electronic draft capture to the issuer system.

3. The method of claim 1, wherein the rate matching score is determined based on the transaction information of the transaction request, historical information for a merchant, and the exchange rate scoring model.

4. The method of claim 3, wherein the transaction information comprises a merchant identifier, a foreign transaction amount, a purchase category of the first transaction, and a merchant category.

5. The method of claim 1, wherein the first currency is a foreign currency relative to a customer and wherein the second currency is a domestic currency relative to the customer.

6. The method of claim 1, wherein the rate matching score is based on a foreign transaction amount, the first currency, and the second currency.

7. The method of claim 1, wherein the exchange rate scoring model comprises a supervised deep learning model.

8. The method of claim 2, wherein the cross-currency transaction policy is based on historical information for a merchant, a foreign transaction amount, a purchase category of the first transaction, and a merchant category.

9. The method of claim 2, wherein the cross-currency transaction policy is based on historical information for a merchant.

10. A system comprising:
a payment processing server comprising one or more processors coupled to a memory, the memory comprising instructions stored thereon, cause the payment processing server to:
receive a transaction request to authorize a first transaction, wherein the transaction request comprises a transaction amount in a first currency and transaction information;
determine a first exchange rate between the first currency and a second currency, wherein the first exchange rate is determined at an authorization time;
calculate a rate matching score for the first transaction according to an exchange rate scoring model, wherein the rate matching score indicates a suitability to calculate a clearing transaction amount with the first exchange rate at a clearing time;
determine the rate matching score meets a threshold score, wherein the threshold score for calculating the clearing transaction amount with the first exchange rate at the clearing time;
store the transaction information and the first exchange rate to a rate matching database, at the authorization time; and
transmit a notification to an issuer system, wherein the notification comprises an authorization transaction amount in the second currency, and wherein the authorization transaction amount is based on the first exchange rate, and wherein the notification is transmitted before the clearing time.

11. The system of claim 10, wherein the instructions further cause the payment processing server to:
receive an electronic draft capture associated with the transaction request;
evaluate a cross-currency transaction policy during the clearing time;
determine the first transaction is eligible to use the first exchange rate to calculate the transaction amount in the second currency at the clearing time, based on the cross-currency transaction policy;
transmit a rate matching request to the rate matching database, wherein the rate matching request comprises the transaction information necessary to determine the first exchange rate;
generate the clearing transaction amount based on the first exchange rate; and
transmit the clearing transaction amount and the electronic draft capture to the issuer system.

12. The system of claim 10, wherein the rate matching score is determined based on the transaction information of the transaction request, historical information for a merchant, and the exchange rate scoring model.

13. The system of claim 12, wherein the transaction information comprises a merchant identifier, a foreign transaction amount, a purchase category of the first transaction, and a merchant category.

14. The system of claim 10, wherein the first currency is a foreign currency relative to a customer and wherein the second currency is a domestic currency relative to the customer.

15. The system of claim 10, wherein the rate matching score is based on a foreign transaction amount, the first currency, and the second currency.

16. The system of claim 10, wherein the exchange rate scoring model comprises a supervised deep learning model.

17. The system of claim 11, wherein the cross-currency transaction policy is based on historical information for a merchant, a foreign transaction amount, a purchase category of the first transaction, and a merchant category.

18. The system of claim 11, wherein the cross-currency transaction policy is based on historical information for a merchant.

19. A method comprising:
receiving, by a computer system, a transaction request to authorize a first transaction, wherein the transaction request comprises a transaction amount in a first currency and transaction information;
determining, by the computer system, a first exchange rate between the first currency and a second currency, wherein the first exchange rate is determined at an authorization time;
calculating, by the computer system, a rate matching score for the first transaction according to an exchange rate scoring model, wherein the rate matching score indicates a suitability to calculate a clearing transaction amount with the first exchange rate at a clearing time;
determining, by the computer system, the rate matching score meets a threshold score, wherein the threshold score for calculating the clearing transaction amount with the first exchange rate at the clearing time;
storing, by the computer system, the transaction information and the first exchange rate to a rate matching database, at the authorization time;
evaluating, by the computer system, a cross-currency transaction policy during the clearing time;
determining, by the computer system, the first transaction is eligible to use the first exchange rate to calculate the transaction amount in the second currency at the clearing time, based on the cross-currency transaction policy;
generating, by the computer system, the clearing transaction amount based on the first exchange rate; and
transmitting, by the computer system, the clearing transaction amount and an electronic draft capture associated with the transaction request to an issuer system.
